(19) United States
(12) Patent Application Publication
(10) Pub. No.: US 2026/0268380 A1
(43) Pub. Date: Sep. 10, 2026

(54) INFORMATION PROCESSING APPARATUS, SYSTEM, AND CONTROL METHOD THEREFOR

(71) Applicant: CANON KABUSHIKI KAISHA, Tokyo (JP)

(72) Inventor: KEIICHI IIMOTO, Tokyo (JP)

(21) Appl. No.: 19/553,911

(22) Filed: Mar. 2, 2026

(30) Foreign Application Priority Data
Mar. 4, 2025 (JP) 2025-033369

(51) Int. Cl. G06Q 30/0601

(52) U.S. Cl. CPC G06Q 30/0601

(57) ABSTRACT

A management server determines, based on printer status information received from a printer, whether an ink consumption amount of each ink bottle has reached a threshold. If the ink consumption amount of any ink bottle has reached the threshold, the management server performs an ordering process for delivering together an ink bottle for which the ink consumption amount has reached the threshold and an ink bottle for which the ink consumption amount has not reached the threshold. In this ordering process, an order is placed such that, for an ink bottle for which the ink consumption amount has reached the threshold, a full ink bottle is delivered, and for an ink bottle for which the ink consumption amount has not reached the threshold, an ink bottle filled in an amount of ink corresponding to the ink consumption amount is delivered.

### BACKGROUND

### Field of the Technology

The present disclosure relates to an information processing apparatus, a system, and a control method therefor.

### Description of the Related Art

Recording apparatuses capable of connecting to the Internet and communicating with web servers have been introduced.

Japanese Patent Laid-Open No. 2022-45015 proposes a consumable ordering system in which a recording apparatus detects remaining amounts of consumables in the recording apparatus, and in a case where a remaining amount of any of the plurality of consumables becomes less than or equal to a predetermined threshold, orders the consumable whose remaining amount has become less than or equal to the predetermined threshold.

However, in the technique described in Japanese Patent Laid-Open No. 2022-45015, it is assumed that an ink bottle for a color for which the ink consumption amount has reached a predetermined consumption amount is ordered, and that a full ink bottle is delivered. Thus, when ink consumption amounts differ among colors, the ink consumption amount for each color reaches the predetermined consumption amount at a different time, which results in an increased number of ink-bottle deliveries.

### SUMMARY

Embodiments herein have been made in view of the above issue. The present disclosure is directed to providing a mechanism that reduces the number of deliveries of consumables, thereby reducing delivery costs and mitigating environmental impact.

According to an aspect of the present disclosure, an information processing apparatus configured to communicate with an image forming apparatus that includes a plurality of tanks, each tank being configured to be filled with a recording material of a respective different color, the image forming apparatus configured to form an image on a recording medium using the recording material supplied from the plurality of tanks, includes one or more processors; and one or more memories storing instructions that, when executed by the one or more processors, cause the information processing apparatus to receive information regarding a consumption amount of the recording material corresponding to each tank transmitted from the image forming apparatus, determine whether the consumption amount of the recording material for each of the plurality of tanks has reached a predetermined threshold based on the received information regarding the consumption amount of the recording material, and perform, in a case where the consumption amount of the recording material corresponding to at least one tank of the plurality of tanks has reached the threshold, an ordering process for delivering together a bottle corresponding to a color for which the consumption amount of the recording material has reached the threshold and a bottle corresponding to a color for which the consumption amount of the recording material has not reached the threshold, wherein the ordering process causes delivering a first bottle filled with a first amount of the recording material for the color for which the consumption amount of the recording material has reached the threshold, and delivering a second bottle filled with a second amount of the recording material for the color for which the consumption amount of the recording material has not reached the threshold, the second amount being determined according to the consumption amount of the recording material corresponding to the color for which the consumption amount of the recording material has not reached the threshold and being smaller than the first amount.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a consumable ordering system according to an embodiment.

FIG. 2 is a diagram illustrating a hardware configuration of a server according to an embodiment.

FIG. 3 is a diagram illustrating a hardware configuration of a printer according to an embodiment.

FIGS. 4A to 4C are schematic diagrams illustrating a printer according to an embodiment.

FIG. 5 is a sequence diagram at the time of subscribing to a consumable ordering service according to an embodiment.

FIG. 6 is a flowchart illustrating processing for transmitting printer status information performed by the printer according to an embodiment.

FIG. 7 is a flowchart illustrating a process of ordering consumables performed by a management server according to an embodiment.

FIGS. 8A to 8D are schematic diagrams illustrating examples of an operation screen for clearing an ink bottle consumption amount counter, displayed by a display unit, according to an embodiment.

FIG. 9 is a diagram illustrating an example of the number of delivery times estimated from ink consumption amounts according to a conventional ink delivery form.

FIG. 10 is a diagram illustrating an example of the number of delivery times estimated from ink consumption amounts in an ink delivery form according to an embodiment.

FIGS. 11A and 11B are diagrams illustrating various tables stored in a database of the management server in a case where delivery is performed in units of ink bottles filled with ink of a color for which the ink consumption amount has reached a threshold.

FIGS. 12A and 12B are diagrams illustrating various tables stored in a database of the management server in a case where an ink bottle filled with ink of a color for which the ink consumption amount has reached a threshold is delivered together with an ink bottle into which an amount of ink corresponding to the consumed amount has been injected for a color for which the ink consumption amount has not reached the threshold.

FIGS. 13A to 13C is a diagram schematically illustrating an ink bottle consumption amount.

### DESCRIPTION OF THE EMBODIMENTS

Hereinafter, embodiments for carrying out the disclosure will be described in detail with reference to the attached drawings. It should be noted that the following embodiments do not limit the present disclosure as defined by the claims, and that not all combinations of features described in the embodiments are necessarily essential to the present disclosure.

### Configuration of Consumable Ordering System 100

Hereinafter, a configuration of a consumable ordering system 100 of an embodiment will be described.

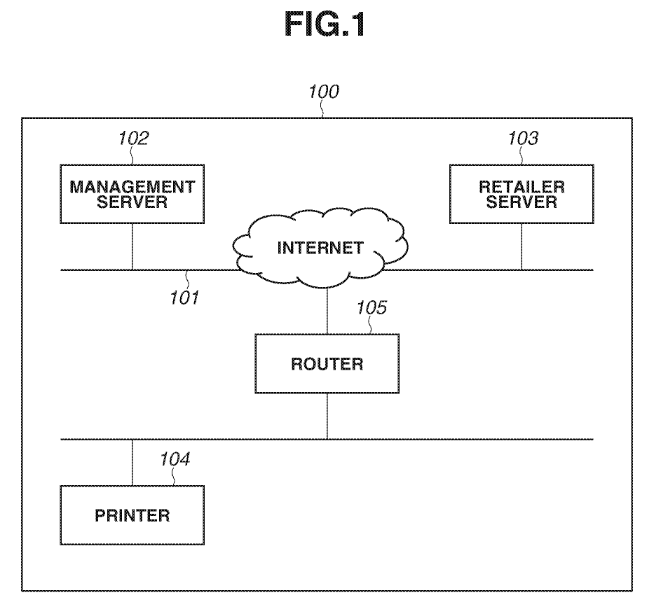

FIG. 1 is a diagram illustrating an example of the configuration of the consumable ordering system 100 according to an embodiment of the present disclosure.

The consumable ordering system 100 according to the present embodiment includes a recording apparatus and a server system including one or more servers. For example, as illustrated in FIG. 1, the consumable ordering system 100 includes a management server 102, a retailer server 103, and a printer 104 that is a recording apparatus (image forming apparatus).

The management server 102 and the retailer server 103 are each connected to the Internet 101. The printer 104 is connectable to the Internet 101 via a router 105. At least the printer 104 and the management server 102 communicate with each other via the Internet 101.

The management server 102 is a management apparatus that manages information transmitted from the printer 104.

The management server 102 provides the information transmitted from the printer 104 to the retailer server 103 via the Internet 101.

Control of each communication is performed via protocols, such as HyperText Transfer Protocol (HTTP), eXtensible Messaging and Presence Protocol (XMPP), among other protocols. The protocol is not limited to these, and other protocols may be used.

### Configuration of Server

Hereinafter, a configuration of the management server 102 will be described.

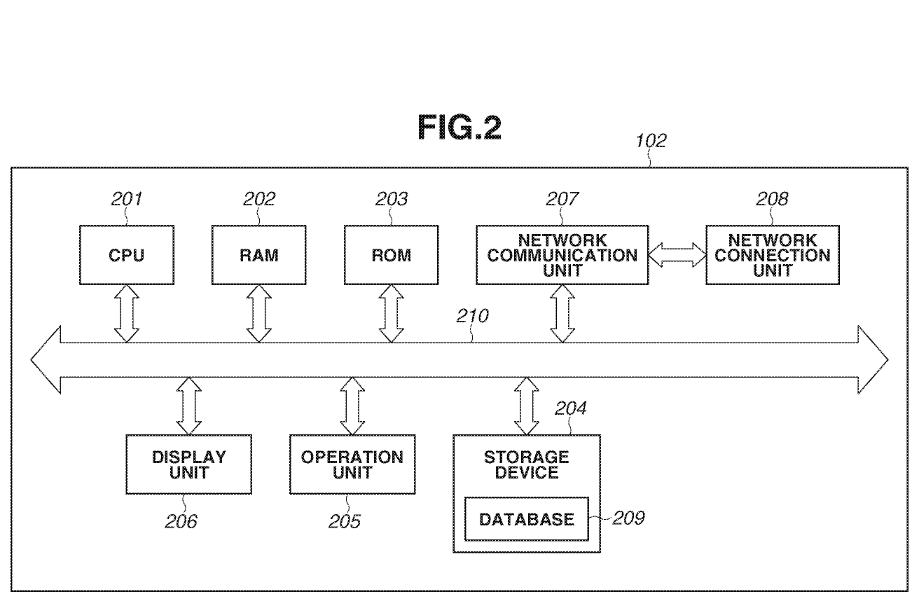

FIG. 2 is a block diagram illustrating an example of a hardware configuration of the management server 102.

The management server 102 includes a Central Processing Unit (CPU) 201, a Random Access Memory (RAM) 202, a Read Only Memory (ROM) 203, a storage device 204, an operation unit 205, a display unit 206, a network communication unit 207, and a network connection unit 208.

The CPU 201 controls each unit of the management server 102.

The RAM 202 serves as a working memory to be used when the CPU 201 executes a program.

The ROM 203 stores programs executed by the CPU 201.

The storage device 204 is a device for storing a database 209 and various types of information, and is, for example, a non-volatile storage device, such as a magnetic disk or a flash memory.

The operation unit 205 includes a keyboard, a mouse, and other components for a user to perform various input operations.

The display unit 206 is configured as, for example, a Liquid Crystal Display (LCD), and displays various types of information to be presented to the user.

The network communication unit 207 is connected to a network, such as the Internet 101, via the network connection unit 208, and performs various communications.

The respective units described above are connected to each other by a bus 210 which transmits data to and receives data from each other.

The retailer server 103 includes the same hardware configuration as the management server 102, and a description thereof will be omitted. However, the retailer server 103 may have a hardware configuration different from that of the management server 102. In FIG. 2, the retailer server 103 and the management server 102 each include one server, but each may be configured as a server system including one or more servers. Alternatively, the retailer server 103 and the management server 102 may each be configured to operate on a virtual server using a cloud service.

### Hardware Configuration of Printer

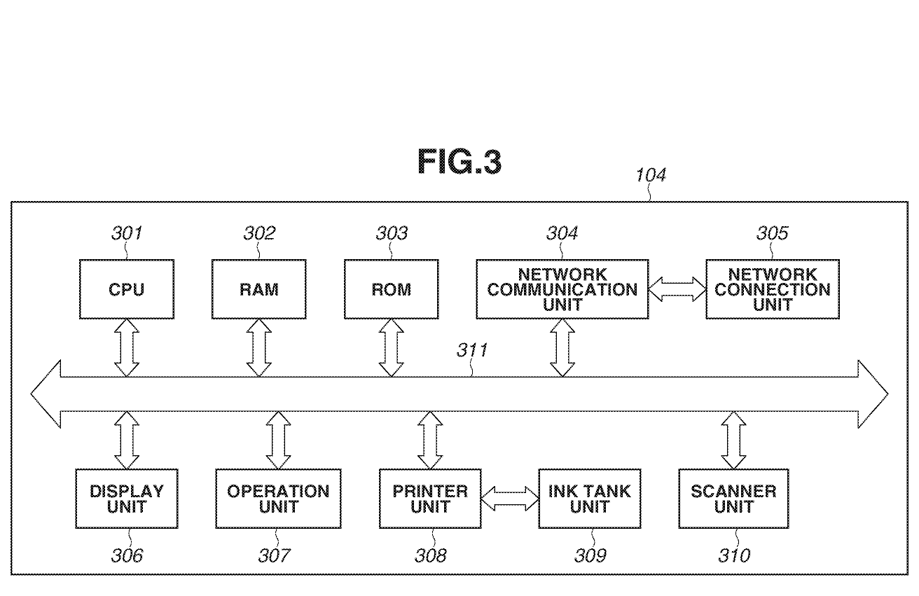

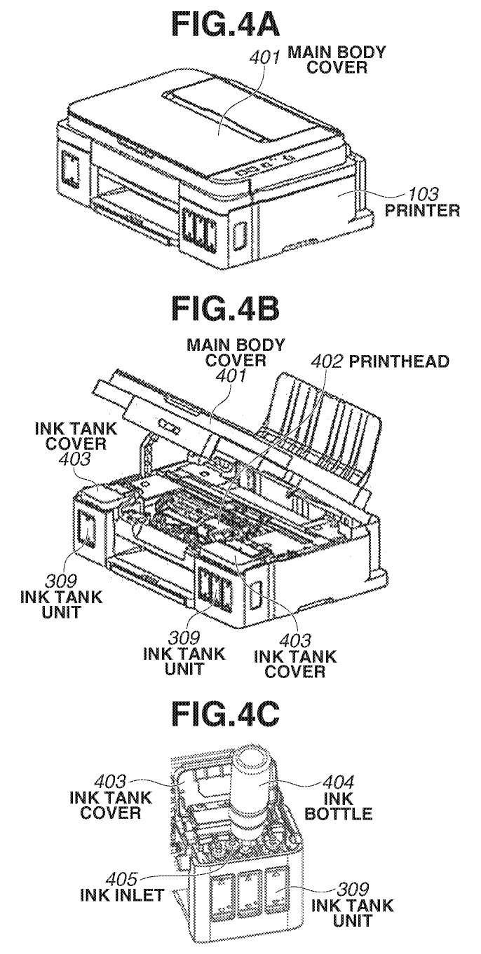

Hereinafter, a configuration of the printer 104 in the present embodiment will be described with reference to FIGS. 3 and 4.

FIG. 3 is a block diagram illustrating an example of a hardware configuration of the printer 104.

FIGS. 4A to 4C are schematic diagrams each illustrating an example of the printer 104. FIG. 4A illustrates a state in which a main body cover 401 of the printer 104 is closed. FIG. 4B illustrates a state in which the main body cover 401 of the printer 104 is open. FIG. 4C illustrates a state in which ink is being injected (refilled) from an ink bottle 404 into an ink inlet 405 of an ink tank unit 309 included in the printer 104. For an ink cartridge type printer, ink is refilled by replacing an old ink cartridge installed in the printer with a new ink cartridge. However, for an ink bottle type printer, such as the printer 104, ink is refilled by injecting ink, from an ink bottle, into an ink tank in the printer.

The printer 104 includes a printer unit 308, a scanner unit 310, and ink tank units 309. The printer 104 further includes a CPU 301, a RAM 302, a ROM 303, a network communication unit 304, a network connection unit 305, a display unit 306, an operation unit 307, and other components.

In the present embodiment, the printer 104, which is a multifunction peripheral, will be described as an example of an image recording apparatus (image forming apparatus), but an image recording apparatus to which the present embodiment is applicable is not limited to a printer. As the image recording apparatus, a copying machine, a facsimile, or the like may be used, or alternatively, a printer without a scanning function may be used.

In the printer 104, a printing function is realized by the printer unit 308, and a scanning function is realized by the scanner unit 310.

Each ink tank unit 309 is provided for a respective ink color and stores ink. As illustrated in FIG. 4C, each ink tank unit 309 includes an ink inlet 405 located under an ink tank cover 403. A user can open the ink tank cover 403, insert the tip of the ink bottle 404 into the ink inlet 405, and refill ink from the ink bottle 404 into the corresponding ink tank unit 309, which serves as a storage container.

In the present embodiment, it is assumed that the capacity of the ink bottle 404 is larger than the capacity of the ink tank in each ink tank unit 309, and that ink can be injected a plurality of times with a single ink bottle. However, the present embodiment is applicable to cases other than the case where the capacity of the ink bottle 404 is larger than the capacity of the ink tank in each ink tank unit 309. For example, the capacity of the ink bottle 404 may be equal to, or smaller than, the capacity of the ink tank in each ink tank unit 309. In addition, ink can be refilled into an ink tank even in a state where ink remains in the ink tank. For example, ink can be refilled to bring the ink tank to a full state when the remaining amount of ink in the ink tank is about one half of its full capacity.

The printer unit 308 includes a printhead 402 which is an ink ejection unit, and ink is supplied from the respective ink tank units 309 to the printhead 402 via tubes. Further, the printer unit 308 performs printing using an inkjet method in which an image is recorded on a recording medium, such as a printing sheet (not illustrated), by ejecting ink from the printhead 402 based on image data received from an external apparatus, image data read from the scanner unit 310, or the like.

The printer unit 308 manages the remaining amount of ink in each of the respective ink tanks (hereinafter referred to as "ink-tank ink information"), an ink consumption amount of the respective ink bottles (hereinafter referred to as "ink-bottle ink information"), and sheet information including information about the number of sheets loaded in the printer 103. The ink-tank ink information, the ink-bottle ink information, and the sheet information managed by the printer unit 308 may be managed by being stored in a non-volatile memory (not illustrated) provided in the printer unit 308. Alternatively, these pieces of information may be managed by, for example, being stored in the ROM 303 that is configured as a flash memory or in another storage unit. The ink information and the sheet information as described above may also be managed by other components in the printer 104 instead of the printer unit 308.

A method for specifying the above-described ink information will now be described.

The printer 104 determines the ink remaining amount in each ink tank unit 309 (hereinafter referred to as "ink-tank remaining amount") and the ink consumption amount in each ink bottle (hereinafter referred to as "ink bottle consumption amount"). For example, in the printer 104, the printer unit 308 counts the discharge amounts of inks of respective colors discharged from the printhead 402, manages these count values, and determines the consumption amount of each color ink based on these count values. Furthermore, the printer 104 determines the remaining amount of each ink tank (ink-tank ink information) based on the determined consumption amount of the corresponding color ink. The printer 104 also determines the consumption amount for each ink bottle (ink-bottle ink information) based on the count value indicating the discharge amount of the corresponding color ink discharged from the printhead 402. Although an example has been described in which the ink tank remaining amounts are determined based on the count values indicating the ink discharge amounts, a residual-liquid sensor, a weight sensor, or the like may be provided in each ink tank, and the ink tank remaining amount may be detected based on a value detected by such a sensor. Further, the ink bottle consumption amount may be determined based on a difference between the ink tank remaining amount detected in the current detection and the ink tank remaining amount detected in the previous detection. The methods for determining the ink tank remaining amount and the ink bottle consumption amount are not limited to these, and any method may be used.

The ink-tank ink information and the ink-bottle ink information determined in this way are managed by the printer 104 as described above.

In a case where the printer 104 determines that the remaining amount of an ink tank specified as described above is a remaining amount at which ink is to be refilled, the printer 104 notifies the user via the display unit 306 that ink refilling is to be performed. Thus, the user can perform ink refilling at an appropriate timing.

The scanner unit 310 optically reads an original set on a platen (not illustrated), converts the original into electronic data, and further converts the electronic data into a designated file format. The scanner unit 310 then transmits the resulting image data to an external apparatus via a network and/or stores the image data in a storage area (not illustrated), such as a hard disk drive (HDD). In addition, the scanner unit 310 reads an original placed on the platen to generate image data, and transfers the image data to the printer unit 308. The printer unit 308 then records an image on a recording medium based on the image data, thus realizing a copy function.

The CPU 301 controls each unit in the printer 104.

The ROM 303 stores various program codes, an application program for communicating with the management server 102 (hereinafter referred to as "application"), and the like. A module of the application generates printer status information described below.

In the RAM 302, image data and the like are temporarily stored or buffered during the execution of each service.

The display unit 306 is configured as, for example, an LCD, and displays various types of information.

The operation unit 307 includes switches and other components for the user to perform various input operations.

The network communication unit 304 is connected to the router 105 via the network connection unit 305. Specifically, the network communication unit 304 connects to a network, such as the Internet 101, via the network connection unit 305 and performs various types of communications. In these communications, communication control is performed using protocols, such as HTTP and XMPP. The protocols are not limited to these, and other protocols may be used. In addition, the RAM 302 stores image data and the like received by the network communication unit 304.

The respective units described above are interconnected via a bus 311 and can transmit and receive data to and from one another.

### Subscription to Consumable Ordering Service

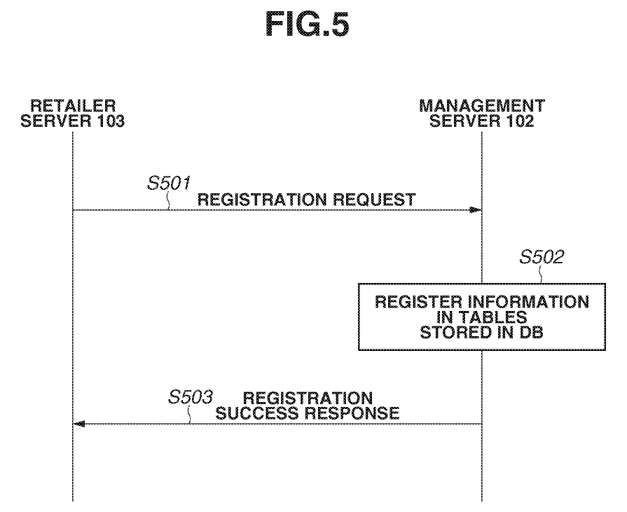

Hereinafter, a process from subscription to the consumable ordering service to ordering of consumables in the present embodiment will be described with reference to FIG. 5.

FIG. 5 is a sequence diagram illustrating an example of a process executed by the management server 102 and the retailer server 103 at the time of subscription to the consumable ordering service.

The series of processes illustrated in the sequence of FIG. 5 is performed by the CPUs of the management server 102 and the retailer server 103 reading out program codes stored in a disk device or the like, loading the read program codes into a corresponding one of the RAMs 202 and 302, and executing the program codes. Alternatively, functions implemented in some or all of the steps in FIG. 5 may be realized by hardware, such as an ASIC or an electronic circuit.

In response to receiving an application for subscription to the consumable ordering service from a user, the retailer server 103 executes the processing in step S501.

In step S501, the retailer server 103 transmits a registration request to the management server 102.

The registration request transmitted in step S501 includes various types of information, such as an identifier (a serial number in this embodiment) for identifying the printer 104, date and time, a consumable type, and a model number of an ink bottle. The information about the consumable type indicates, for example, when a consumable is ink, whether the consumable is an ink cartridge type or an ink bottle type. Further, while a serial number has been described here as an example of information for identifying a printer, other types of information, such as a MAC address, may be used.

In response to receiving the registration request from the retailer server 103, the management server 102 executes the processing in step S502.

In step S502, the management server 102 registers the information obtained in step S501 in a plurality of tables stored in the database 209. Hereinafter, the tables will be described.

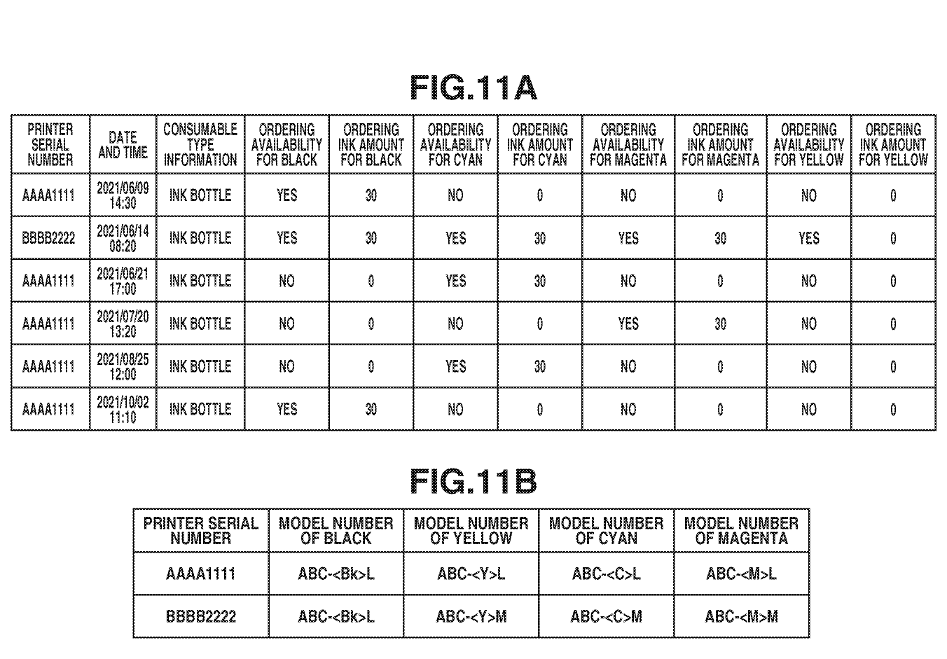

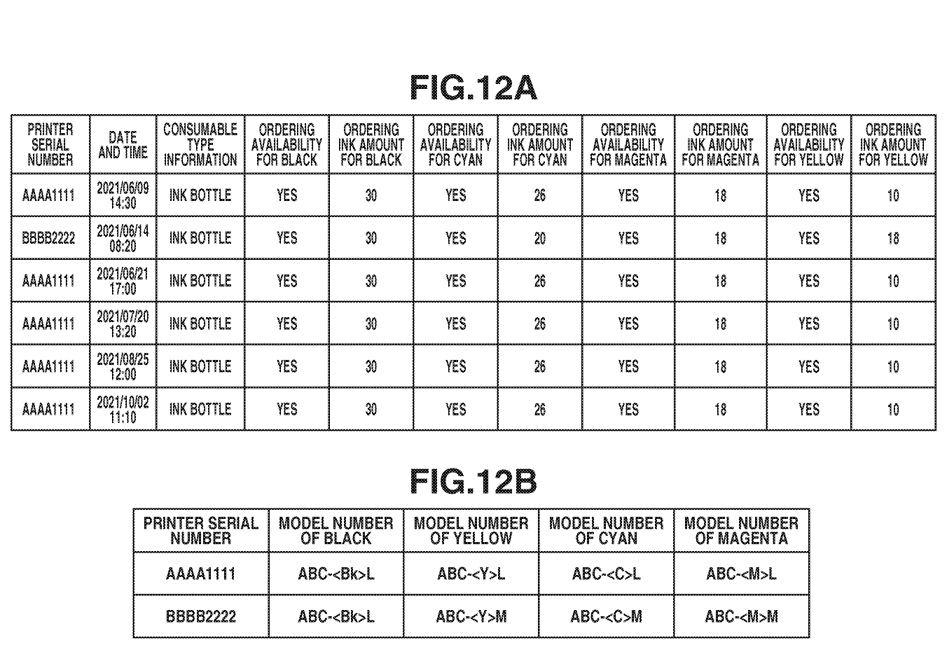

FIGS. 11A and 12A are diagrams illustrating examples of a printer management table, and FIGS. 11B and 12B are diagrams illustrating an ink model number table.

In particular, FIG. 11A illustrates an example of a printer management table in a case where delivery is performed in units of ink bottles filled with ink of a color for which the ink consumption amount has reached a threshold (a "first ink delivery method" described below).

FIG. 12A illustrates an example of a printer management table in a case where an ink bottle filled with ink of a color for which the ink consumption amount has reached a threshold is delivered together with an ink bottle into which an amount of ink corresponding to the consumed amount has been injected for a color for which the ink consumption amount has not reached the threshold (a "second ink delivery method" described below). The printer management table is stored in the database of the management server 102.

The management server 102 stores, in the printer management table, the serial number of the printer 104 and the information about the consumable type, which are included in the registration request received from the retailer server 103, in association with each other. Further, in the printer management table, a date and time and information indicating ordering availability for the ink bottle for each color (hereinafter referred to as "ordering availability information") are stored in association with the corresponding serial number.

In the ordering availability information, if no order has been placed and ordering is possible to the retailer server 103, "YES" is registered as a value indicating that ordering is allowed. In other states, "NO" is registered in the ordering availability information as a value indicating that ordering is unnecessary. "NO" is registered in the ordering availability information as an initial value at the time of service registration.

For the ordering availability information indicating "YES", information indicating an amount of ink to be injected into an ink bottle to be ordered (hereinafter referred to as "ordering ink amount information", for example, the unit is "mL") is registered. For the ordering availability information indicating "NO", "0" is registered in the ordering ink amount information. For example, the first row in the table in FIG. 12A indicates a state in which a Black ink bottle is orderable with an ink amount of "30 mL", a Cyan ink bottle is orderable with an ink amount of "26 mL", a Magenta ink bottle is orderable with an ink amount of "18 mL", and a Yellow ink bottle is orderable with an ink amount of "30 mL".

FIG. 11B and FIG. 12B are diagrams illustrating examples of the ink model number table.

The management server 102 stores, in the ink model number table, the serial number of the printer 104 and the model number of the ink bottle of each color, which are included in the registration request received from the retailer server 103, in association with each other.

Hereinafter, the description returns to FIG. 5.

In step S503, the management server 102 returns, to the retailer server 103, a response in response to the registration request received in step S501. If the registration is successful in step S502, the management server 102 returns a response indicating registration success (hereinafter referred to as "registration success response") to the retailer server 103. If the registration fails in step S502, the management server 102 returns a response indicating registration failure (hereinafter referred to as "registration failure response") to the retailer server 103.

### Transmission Processing of Consumable Information by Printer

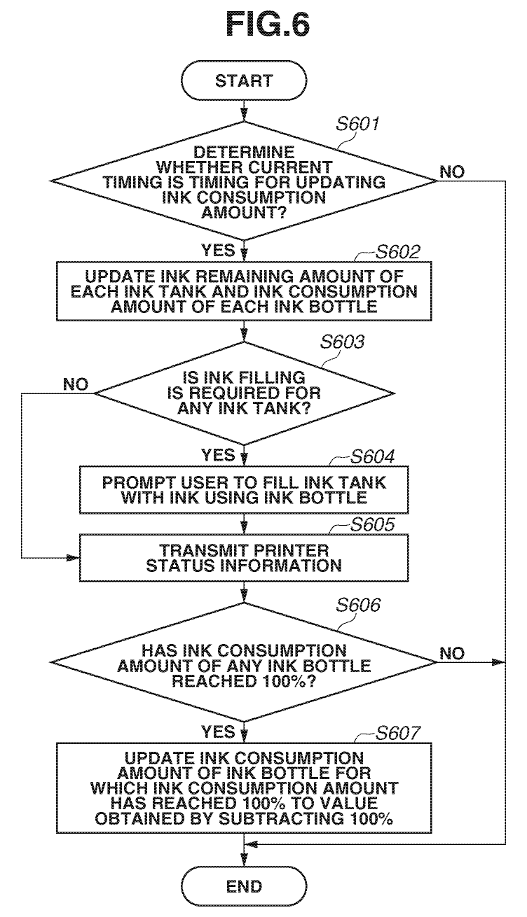

Hereinafter, a process in which the printer 104 transmits consumable information to the management server 102 will be described with reference to FIG. 6.

FIG. 6 is a flowchart illustrating a process in which the printer 104 transmits printer status information including consumable information to the management server 102. A series of processes illustrated in the flowchart of FIG. 6 is performed by the CPU 301 of the printer 104 reading out program codes stored in a disk device or the like, loading the read program codes into the RAM 302, and executing the program codes.

The process of this flowchart is performed at a timing when the ink consumption amount is updated. Examples of timings at which the ink consumption amount is updated includes soft power-on, after cover closing, after cleaning, during cleaning, before cleaning at the time of arrival, and after capping. The timing at which the ink consumption amount is updated is not limited to these.

In step S601, the CPU 301 of the printer 104 determines whether the current timing corresponds to the timing for updating the ink consumption amount in the printer 104.

If the CPU 301 determines that the current timing does not correspond to the timing for updating the ink consumption amount (NO, in step S601), the printer 104 ends the processing without transmitting the consumable information to the management server 102.

If the CPU 301 determines that the current timing corresponds to the timing for updating the ink consumption amount (YES, in step S601), processing proceeds to step S602.

In step S602, the CPU 301 performs processing for updating ink-tank ink information (i.e., information about the ink remaining amount for each ink tank) and ink-bottle ink information (i.e., information about the ink consumption amount for each ink bottle). For example, the CPU 301 specifies the ink consumption amount of each ink tank based on the count value of the discharge amount of the corresponding color ink discharged from the printhead 402 after execution of the previous update processing. The CPU 301 then further specifies the ink remaining amount of each ink tank and the ink consumption amount of each ink bottle based on the specified consumption amount of the corresponding ink tank, and updates these values managed by the printer 104.

Next, in step S603, the CPU 301 determines whether the value of the ink remaining amount of each ink tank updated in step S602 is a remaining amount at which ink is to be refilled.

In this step, if the CPU 301 determines that none of the ink tanks requires ink refilling (NO, in step S603), the processing proceeds to step S605.

If the CPU 301 determines that the ink remaining amount of at least one of the ink tanks is the remaining amount at which ink is to be refilled (YES, in step S603), the processing proceeds to step S604.

In step S604, the CPU 301 displays, on the display unit 306 of the printer 104, a notification prompting the user to fill the ink tank that has been determined in step S603 to require ink refilling with ink from an ink bottle. The processing then proceeds to step S605.

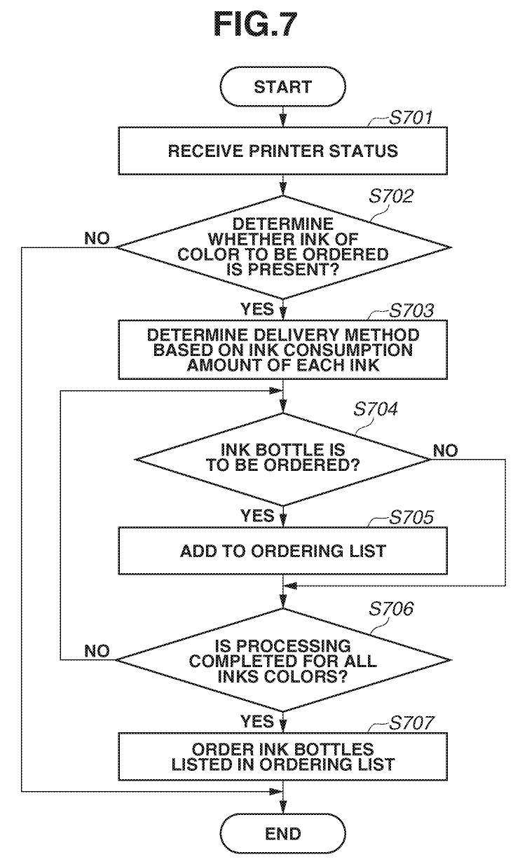

In step S605, the CPU 301 of the printer 104 transmits a printer status, including a printer serial number, consumable information (information including the ink bottle consumption amount for each ink bottle, etc.,), and the like to the management server 102. Further, the CPU 301 of the printer 104 receives, from the management server 102, a response to the transmission of the printer status. As illustrated in FIG. 7 (described below), the management server 102 performs consumable ordering processing based on the printer status, and transmits a response including the ordering result to the printer 104. The printer 104 then receives this response.

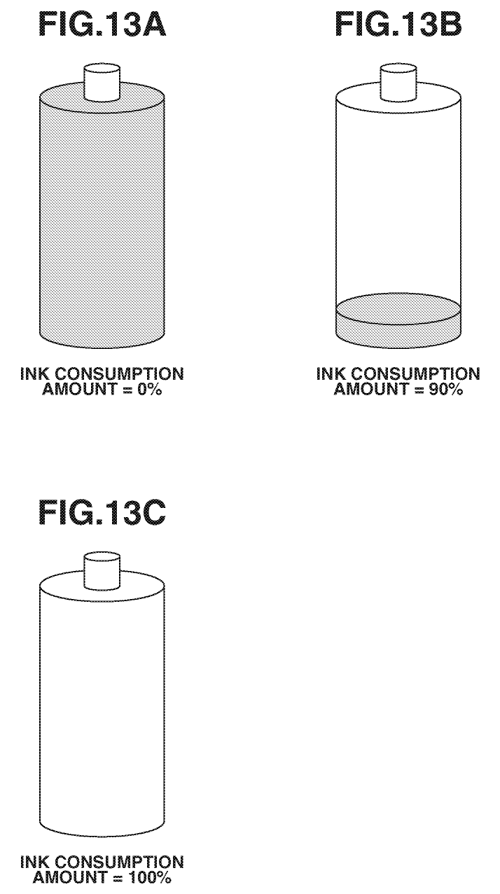

The ink-bottle ordering is performed in a case where the ink consumption amount reaches a certain value (a predetermined threshold), such as 90% of the full-bottle ink amount for one ink bottle, as illustrated in FIG. 13B. The remaining 10% of the ink amount serves a margin that accounts for the time from ordering the ink bottle until the ink bottle reaches the user.

A count value indicating the ink consumption amount (hereinafter referred to as an ink-consumption count value) of an ink bottle for which the ink consumption amount has reached the threshold needs to be cleared not at the timing of ink-bottle ordering but after the ink-consumption count value has reached the full ink amount of one ink bottle (bottle capacity), as illustrated in FIG. 13C. If the ink-consumption count value is cleared at the timing of ink-bottle ordering in a case where a threshold for ordering the ink bottle is set to 90% of the bottle capacity, an error of 10% of the bottle capacity would accumulate each time an ink bottle is ordered. Thus, for an ink bottle ordered full because its ink consumption amount has reached the threshold, the clearing of the ink-consumption count value is not performed until the ink-consumption count value reaches 100% of the bottle capacity. This determination is made in the next step S606. FIG. 13A illustrates a state where the ink consumption amount is 0%.

On the other hand, for an ink bottle for which the ink consumption amount has not reached the threshold and which is ordered to replenish only the amount of ink consumed, the ink-consumption count value needs to be cleared at this point. This is because, if the ink-consumption count value is not cleared upon ordering the ink bottle, a counting error corresponding to the amount of ink injected into the bottle would accumulate each time an ink bottle is ordered. Accordingly, when the response to the transmission of the printer status indicates that ordering has been performed based on the "second ink delivery method" (described below), specifically, a delivery method in which (i) an ink bottle filled to capacity with ink of a color whose ink consumption amount has reached the threshold and (ii) an ink bottle into which ink is injected in an amount corresponding to the consumed amount for a color whose ink consumption amount has not reached the threshold are delivered, the CPU 301 of the printer 104 resets, at this time, the ink-consumption count value for the latter ink bottle (step not illustrated). Specifically, the CPU 301 sets the ink consumption count value for the ink bottle whose ink consumption amount has not reached the threshold to "0", or updates the ink-consumption amount to a value obtained by subtracting, from the current ink-consumption amount, a value corresponding to the ordering ink-amount information included in the response.

In step S606, the CPU 301 of the printer 104 determines whether the ink consumption amount of at least one of the ink bottles updated in step S602 has reached 100% of the ink bottle capacity (corresponding to the ink capacity in a full state of the ink bottle).

In this step, if the CPU 301 determines that none of the ink consumption amounts of the ink bottles has reached 100% of the ink bottle capacity (NO, in step S606), the processing in this flowchart ends.

If the CPU 301 determines that the ink consumption amount of at least one of the ink bottles has reached 100% of the ink bottle capacity (YES, in step S606), the processing proceeds to step S607.

In step S607, for the ink bottle for which it is determined in step S606 that the ink consumption amount has been reached 100% of the ink bottle capacity, the CPU 301 updates the ink bottle consumption amount to a value obtained by subtracting an amount corresponding to 100% of the ink bottle capacity from the ink bottle consumption amount.

The operation in step S607 will now be described using a specific example.

For example, if the CPU 301 determines in step S606 that the ink consumption amount of an ink bottle has reached 105% of the bottle capacity, then in step S607, the CPU 301 updates the ink bottle consumption amount to 5%, which is obtained by subtracting the value corresponding to 100% of the bottle capacity from the value corresponding to 105% ink consumption amount.

In this way, the printer according to the present embodiment counts the amount of ink actually consumed. Accordingly, even if the user replenishes an ink tank of the printer with ink from an ink bottle before the ink‑consumption amount reaches the threshold, a new ink bottle can be ordered at an appropriate timing before the current ink bottle becomes empty. Thus, occurrence of a situation in which the user runs out of ink can be prevented.

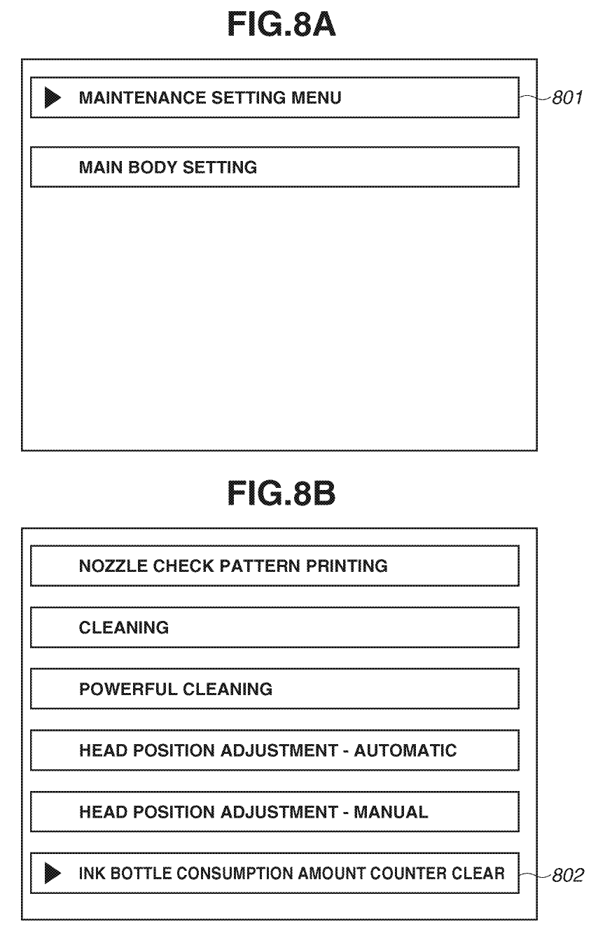

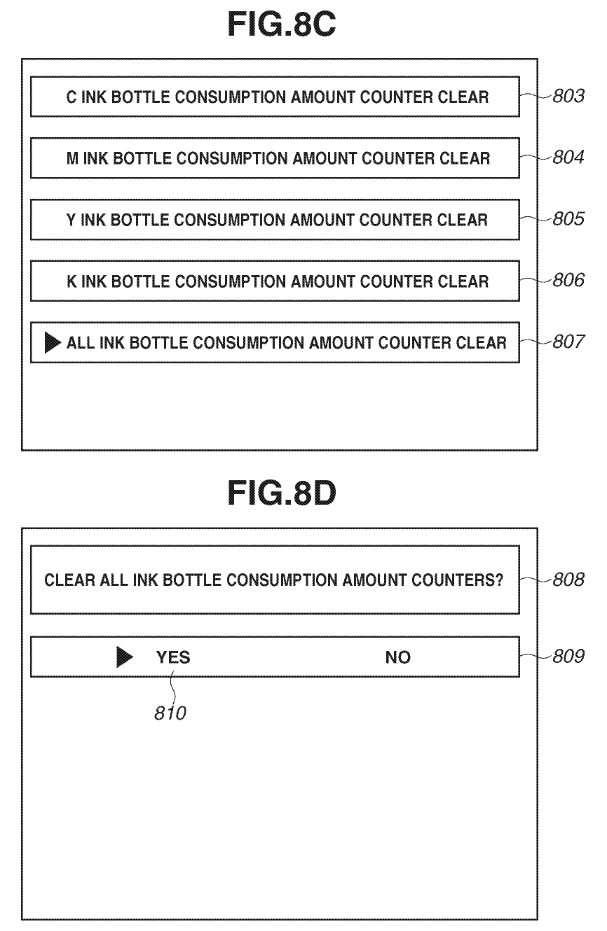

There is a possibility that a user may discard an ink bottle without using it up, lose the ink bottle, or use the ink bottle in another printer. In such cases, the ink-consumption count value may become inaccurate. Accordingly, as illustrated in FIGS. 8A to 8D, the printer 104 according to the present embodiment includes a unit (reset function) for forcibly clearing the ink-consumption count value for each ink bottle. In a case where each ink bottle is used up to the end every time, it is not necessary to forcibly clear the ink-consumption count value. The reset function is used when a new ink bottle is used without the previous ink bottle having been used up, as described above.

Hereinafter, a method for forcibly clearing the ink consumption amount of each ink bottle will be described. In this method, the user selects an item for forcibly clearing the ink consumption amounts (ink-consumption count values) of one or more ink bottles from a maintenance setting menu displayed on the display unit 206 using the operation unit 205.

FIGS. 8A and 8D are schematic diagrams illustrating examples of an operation screen displayed on the display unit 206 for clearing an ink bottle consumption amount counter in the present embodiment.

In response to a predetermined user operation from the operation unit 205, the CPU 301 of the printer 104 displays an operation screen as illustrated in FIG. 8A on the display unit 206.

In response to the user selecting a "maintenance setting menu" 801 from a display menu of the operation screen as illustrated in FIG. 8A, the CPU 301 displays an operation screen as illustrated in FIG. 8B on the display unit 206.

In response to the user selecting an "ink bottle consumption amount counter clear" 802 from a display menu of an operation screen as illustrated in FIG. 8B, the CPU 301 displays an operation screen as illustrated in FIG. 8C on the display unit 206.

In response to the user selecting "all ink bottle consumption amount counter clear" 807 from a display menu of the operation screen as illustrated in FIG. 8C, the CPU 301 displays an operation screen as illustrated in FIG. 8D on the display unit 206.

In response to the user selecting "YES" 810 in a menu 809 displaying "Clear all ink bottle consumption amount counters?" 808 as illustrated in FIG. 8D, the CPU 301 clears the consumption amounts of all ink bottles (updates to "0").

In addition, in response to the user selecting a menu corresponding to a bottle (any of menus 803 to 807) for which ink bottle consumption amount counter is to be cleared (set to 0%) from the display menus on the operation screen as illustrated in FIG. 8C, the CPU 301 displays an operation screen (not illustrated) on the display unit 206. For example, when "C ink bottle consumption amount counter clear" is selected by the user from the display menu of the operation screen as illustrated in FIG. 8C, the CPU 301 displays an operation screen displaying "Clear C ink bottle consumption amount counter?" together with "YES" and "NO". In response to the user selecting "YES" on this operation screen, the CPU 301 clears the consumption amount of the C ink bottle (updates to "0%").

### Ordering Processing of Consumables by Management Server

Hereinafter, a process for ordering consumables from the retailer server 103 by the management server 102 in the present embodiment will be described with reference to FIG. 7.

FIG. 7 is a flowchart illustrating a process (ordering process) in which the management server 102 issues an ink-bottle order notification to the retailer server 103. The processing in each step of FIG. 7 is realized by the CPU 201 of the management server 102 reading program codes stored in the ROM 203 or the storage device 204, loading the read program codes to the RAM 202, and executing the program codes.

In step S701, in response to receiving the printer status information transmitted from the printer 104, the processing proceeds to step S702.

In step S702, based on the printer status information received in step S701, the CPU 201 updates the above-described printer management table and determines whether there is an ink bottle for a color to be ordered. Specifically, for an ink bottle that is in a low-ink status (a state where information indicating the ink bottle consumption amount is equal to or greater than a threshold and less than the capacity of the ink bottle) and is an unordered state in the printer status information, the CPU 201 updates the ordering availability information for the ink bottle to "YES" and updates the ordering ink amount information to the capacity of the ink bottle. In a case where the status has once become the low-ink status and the ordering process has already been performed, the ordering availability information is maintained as "NO" even if the status is the low-ink status. Whether the ink bottle is in an "unordered" state or an "ordered" state is managed by, for example, a flag or the like for each ink bottle of the printer. When the information indicating ink bottle consumption amount included in the printer status information reaches the capacity of the ink bottle, the low-ink status of the ink bottle of the printer is cleared and the state is set to an unordered state. Thus, when the printer status information indicating the low-ink status is received next time, the ordering availability information becomes "YES".

In contrast, for an ink bottle that is not in the low status, the ordering availability information is maintained as "NO".

In a case where the ordering availability information about at least one of the ink bottles has been updated to "YES", the CPU 201 determines there is an ink bottle for a color to be ordered. In contrast, in a case where the ordering availability information about all of the ink bottles is "NO", the CPU 201 determines that there is no ink bottle for a color to be ordered.

Then, if the CPU 201 determines that no ink bottle for a color is to be ordered (NO, in step S702), the CPU 201 transmits a response indicating the determination to the printer 104 (not illustrated), and ends the processing of this flowchart.

If the CPU 201 determines that there is an ink bottle for a color to be ordered (YES, in step S702), the processing proceeds to step S703.

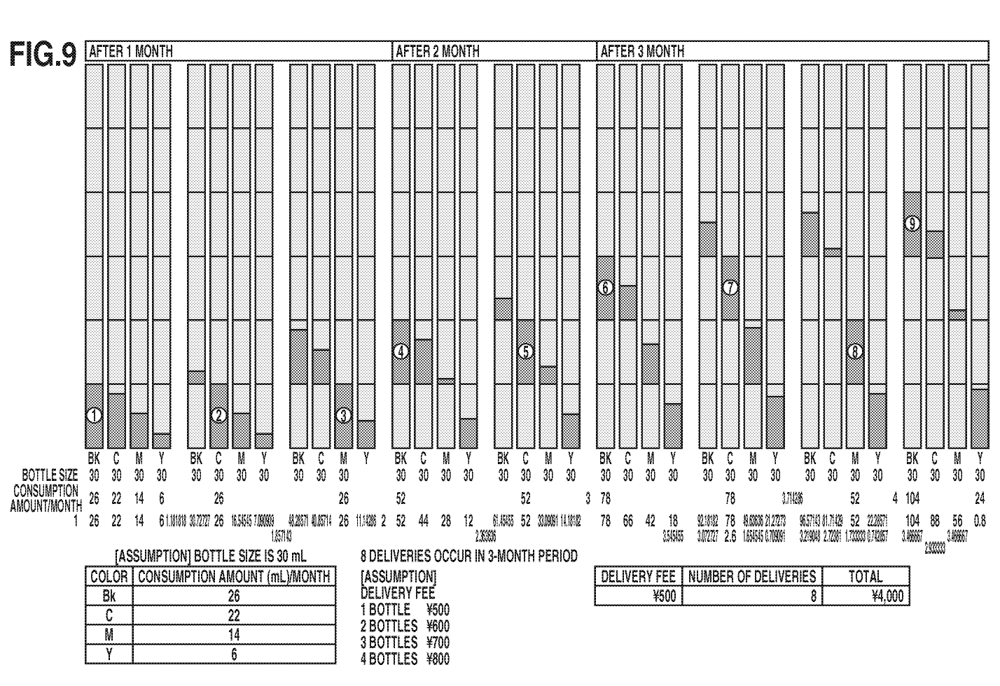

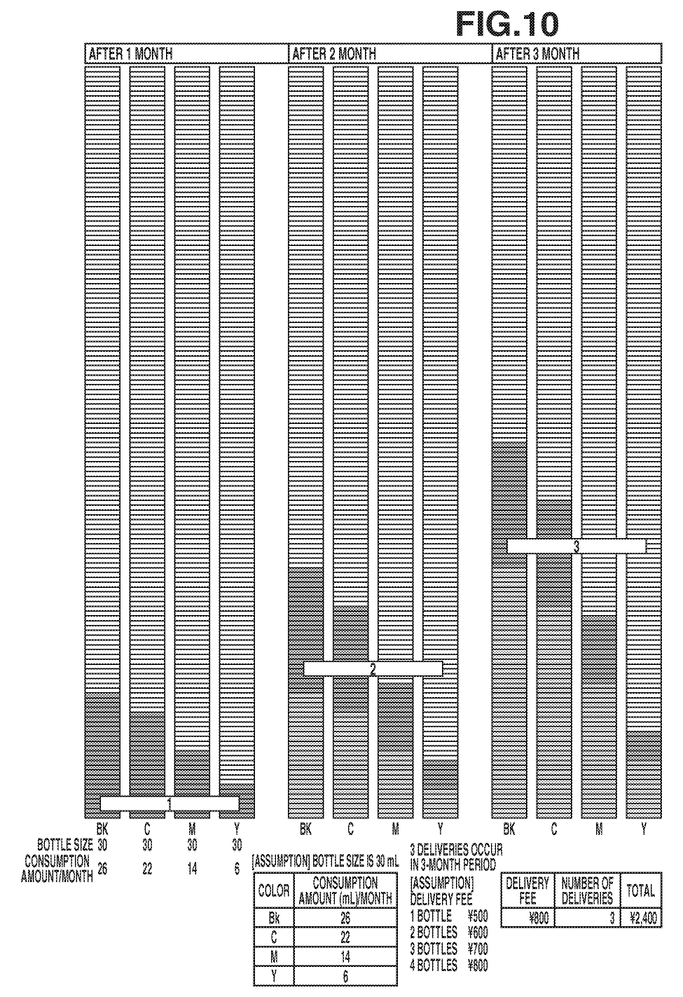

In step S703, the CPU 201 determines, based on the ink consumption amounts in the printer status information received in step S701, a delivery method for ink bottles for which ordering is required. There are two types of delivery methods. In the first delivery method, ink for colors for each of which the ink consumption amount has reached a threshold is delivered in units of full ink bottles, as illustrated in FIG. 9. In the second delivery method, as illustrated in FIG. 10, an ink bottle filled with ink of a color for which the ink‑consumption amount has reached the threshold and an ink bottle injected with ink in an amount equivalent to the consumed amount of ink of a color for which the ink consumption amount has not reached the threshold, are delivered in one shipment. The CPU 201 determines either the ink‑bottle delivery method illustrated in FIG. 9 or the ink‑bottle delivery method illustrated in FIG. 10 based on the ink consumption amount of each ink included in the printer status information received in step S701. The details are described below.

As the delivery method for ink bottles, a method is selected with which the delivery cost of the ink bottles are reduced in a country or a region where the ink bottles are delivered.

For example, in a region where ink bottles are delivered, assume that the bottle capacity of the ink bottle is "30 mL", and that the threshold for delivering an ink bottle for each color is "26 mL". Further, as illustrated in FIGS. 9 and 10, assume that the ink consumption amount for each color per month is 26 mL for Black, 22 mL for Cyan, 4 mL for Magenta, and 6 mL for Yellow. In this case, in the delivery method in which an ink bottle filled with ink is delivered, as illustrated in FIG. 9, delivery of the ink bottle occurs eight times in three months. In contrast, in the delivery method in which the ink amount of the ink bottle is set to an ink‑consumption‑amount unit, as illustrated in FIG. 10, delivery of ink bottles occurs three times in three months. The estimated delivery cost for the three months in this case is obtained as the delivery fee for ink bottles in the region where the ink bottles are delivered, namely, 500 yen for one bottle, 600 yen for two bottles in one shipment, 700 yen for three bottles in one shipment, and 800 yen for four bottles in one shipment. In this case, in the delivery method in which an ink bottle filled with ink is delivered, the delivery cost becomes 500 yen × 8 times = 4,000 yen. In the delivery method in which the ink amount of each ink bottle is set to an ink‑consumption‑amount unit, the delivery cost becomes 800 yen × 3 times = 2,400 yen. In this example, based on the comparison result of the estimated delivery costs, the delivery method with the lower delivery cost is selected. Specifically, in the above example, the delivery method (the second method) in which the ink capacity of the ink bottle is set to the ink‑consumption-amount unit is adopted because this method results in the lower delivery cost.

Next, in steps S704 to S706, the CPU 201 determines whether to order an ink bottle for each target color based on the delivery method determined in step S703.

In step S704, the CPU 201 sets any unprocessed color ink bottle as a target ink bottle, and determines whether to order the target ink bottle. In this step, if the first delivery method is determined in step S703 to be the delivery method, and the ordering availability information about the target ink bottle is "YES", the CPU 201 determines to order the target ink bottle. If "NO", the CPU 201 determines not to order the target ink bottle.

In contrast, if the second delivery method is determined in step S703 to be the delivery method, and the ordering availability information about the target ink bottle is "YES", the CPU 201 determines to order the target ink bottle. In addition, even if the ordering availability information about the target ink bottle is "NO", the CPU 201 updates the value to "YES" and determines to order the target ink bottle. At this time, the CPU 201 updates the ordering ink amount information to the consumption amount of the target ink bottle included in the received printer status information.

In step S704, if the CPU 201 determines not to order the ink bottle for the target color (NO, in step S704), the processing proceeds to step S706.

If the CPU 201 determines to order the ink bottle for the target color (YES, in step S704), the processing proceeds to step S705.

In step S705, the CPU 201 adds the ink bottle for the target color to an ordering list. At this time, the CPU 201 adds the target ink bottle to the ordering list so that the target ink bottle is delivered with an ink capacity according to the ordering ink amount information about the target ink bottle.

After the operation in step S705, the processing proceeds to step S706.

In step S706, the CPU 201 determines whether the ordering determination process for the ink bottle and, if necessary, the ordering process for the ink bottle have been performed for all colors of the ink tanks mounted on the printer 104 (i.e., whether the operations in steps S704 to S705 have been performed).

Here, if there is an ink tank for a color for which the operations in steps S704 to S705 have not yet been performed (NO, in step S706), the processing returns to step S704 and shifts to processing for an ink tank of the next color.

If the operations in steps S704 to S705 have been performed for the ink tanks for all colors (YES, in step S706), the processing proceeds to step S707.

In step S707, the CPU 201 executes a process for ordering the ink bottles listed in the ordering list to the retailer. Specifically, the CPU 201 provides, to the retailer server 103, combination information about the ink colors, the ink bottle model numbers, and the ink capacities listed in the ordering list. In the ordering process, before notifying the retailer server 103, an inquiry may be sent to the user of the printer 104 via e-mail or the like to confirm whether ordering it to be performed. When the user permits the ordering, the ordering may be issued to the retailer server 103. In the present embodiment, such a form in which the user is once inquired about the availability of ordering is also included in the ordering process.

After the operation in step S707, the CPU 201 transmits a response including the details of ordering determined through steps S704 to S706 to the printer 104 (not illustrated), and ends the processing of this flowchart.

While in the present embodiment, the delivery method is determined in step S703 to be either the first delivery method or the second delivery method, a configuration using only the second delivery method may also be adopted.

In the flowchart of FIG. 6 described above, the ink-consumption count value of an ink bottle that has been ordered with full ink because its ink consumption amount has reached the threshold is cleared after the count value has reached the ink amount corresponding to one ink bottle (bottle capacity). In addition, the ink-consumption count value of an ink bottle that has been ordered with an amount of ink corresponding to the consumed amount of ink for which the ink consumption amount has not reached the threshold is cleared at the timing of ordering. However, for an ink bottle that has been ordered with full ink because its ink‑consumption amount has reached the threshold, the ink-consumption count value may alternatively be cleared at the timing of ordering by subtracting an ink amount corresponding to one ink bottle which is the ordering capacity, from the ink-consumption count value (in which case the ink‑consumption amount may become negative).

In the above embodiment, in the case of the second delivery method, for an ink bottle for a color for which the ink-consumption amount has not reached the threshold (e.g., 90% of the bottle capacity), the ink bottle with an ink capacity corresponding to the consumption amount is delivered. Alternatively, an ink bottle selected from a plurality of ink bottles having different capacities provided in advance may be employed for delivery. For example, in a case where three types of bottles, specifically, 10 mL, 20 mL, and 30 mL, are prepared in advance, a 10 mL bottle may be delivered for an ink bottle for a color for which the consumption amount is 10 mL or less, a 20 mL bottle may be delivered for an ink bottle for a color for which the consumption amount is more than 10 mL and 20 mL or less, and a 30 mL bottle may be delivered for an ink bottle for a color for which the consumption amount is more than 20 mL. Thus, the burden of injecting, into an ink bottle, ink in an amount corresponding to the ink‑consumption amount can be reduced.

In a case where the empty capacity of any of the ink tanks managed by the printer 104 becomes larger than the ink remaining amount of the corresponding ink bottle, the CPU 301 of the printer 104 may cause the display unit 306 to display a message indicating that all the remaining ink in the ink bottle can be refilled into the corresponding ink tank.

The management server 102 may be configured to enable a setting (user setting regarding delivery), for each printer, as to whether the first delivery method or the second delivery method is to be used, and to determine the delivery method based on that setting.

As described above, according to the present embodiment, delivery costs in the country or region are estimated to select a delivery method in accordance with the estimated delivery costs, so that ink bottles can be delivered at a low cost.

In addition, the present embodiment can mitigate the environmental impact by reducing the number of deliveries of consumables.

Thus, ink bottles can be delivered at the appropriate timing, at a low cost, and in an environmentally friendly manner.

In the above embodiment, delivery (ordering) of bottles filled with ink to be used in an inkjet printer has been described as an example. However, the present embodiment is also applicable to delivery (ordering) of bottles filled with other recording materials, such as toner used in an electrophotographic printer.

The configurations and contents of the various data described above are not limited to those described herein, and it is obvious that they may be implemented in various configurations and with various contents depending on the intended use or purpose.

Although one embodiment has been described above, the present disclosure may take the form of, for example, a system, an apparatus, a method, a program, or a storage medium. Specifically, the present disclosure may be applied to a system including a plurality of devices, or may be applied to an apparatus composed of a single device.

Further, all configurations combining the above respective embodiments are also included in the embodiments of the present disclosure.

According to the present disclosure, the number of deliveries of consumables can be reduced, thus reducing delivery costs and mitigating the environmental impact.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033369, filed March 4, 2025, which is hereby incorporated by reference herein in its entirety.

What is claimed is:

1. An information processing apparatus configured to communicate with an image forming apparatus that includes a plurality of tanks, each tank being configured to be filled with a recording material of a respective different color, the image forming apparatus configured to form an image on a recording medium using the recording material supplied from the plurality of tanks, the information processing apparatus comprising:
one or more processors; and
one or more memories storing instructions that, when executed by the one or more processors, cause the information processing apparatus to:
receive information regarding a consumption amount of the recording material corresponding to each tank transmitted from the image forming apparatus;
determine whether the consumption amount of the recording material for each of the plurality of tanks has reached a predetermined threshold based on the received information regarding the consumption amount of the recording material; and
perform, in a case where the consumption amount of the recording material corresponding to at least one tank of the plurality of tanks has reached the threshold, an ordering process for delivering together a bottle corresponding to a color for which the consumption amount of the recording material has reached the threshold and a bottle corresponding to a color for which the consumption amount of the recording material has not reached the threshold,
wherein the ordering process causes delivering a first bottle filled with a first amount of the recording material for the color for which the consumption amount of the recording material has reached the threshold, and delivering a second bottle filled with a second amount of the recording material for the color for which the consumption amount of the recording material has not reached the threshold, the second amount being determined according to the consumption amount of the recording material corresponding to the color for which the consumption amount of the recording material has not reached the threshold and being smaller than the first amount.

2. The information processing apparatus according to claim 1, wherein, in a case where the consumption amount of the recording material corresponding to any one of the plurality of tanks has reached the threshold, in the ordering process, either a first delivery method or a second delivery method is selected, and the ordering process is performed based on the selected delivery method, the first delivery method being a method in which delivery of a bottle corresponding to a color corresponding to the recording material for which the consumption amount has reached the threshold is performed and delivery of a bottle corresponding to a color for which the consumption amount of the recording material has not reached the threshold is not performed, and the second delivery method being a method in which a bottle corresponding to a color for which the consumption amount of the recording material has reached the threshold and a bottle corresponding to a color for which the consumption amount of the recording material has not reached the threshold are delivered together.

3. The information processing apparatus according to claim 2, wherein the instructions cause the information processing apparatus to estimate a delivery cost for the first delivery method and a delivery cost for the second delivery method, and to select one of the delivery methods based on a comparison result of the estimated delivery costs.

4. The information processing apparatus according to claim 2, wherein the instructions cause the information processing apparatus to select one of the delivery methods based on a user setting regarding delivery.

5. The information processing apparatus according to claim 1, wherein the instructions further cause the information processing apparatus to respond with a result of the ordering process to the image forming apparatus.

6. A system in which an information processing apparatus and an image forming apparatus communicate with each other, the image forming apparatus including a plurality of tanks, each tank being configured to be filled with a recording material of a respective different color, and configured to form an image on a recording medium using the recording material supplied from the plurality of tanks,
the information processing apparatus comprising:
one or more processors; and
one or more memories storing instructions that, when executed by the one or more processors, cause the information processing apparatus to:
receive information regarding a consumption amount of the recording material corresponding to each tank transmitted from the image forming apparatus;
determine whether the consumption amount of the recording material for each of the plurality of tanks has reached a predetermined threshold based on the received information regarding the consumption amount of the recording material; and
perform, in a case where the consumption amount of the recording material corresponding to at least one tank of the plurality of tanks has reached the threshold, an ordering process for delivering together a bottle corresponding to a color for which the consumption amount of the recording material has reached the threshold and a bottle corresponding to a color for which the consumption amount of the recording material has not reached the threshold,
wherein the ordering process causes delivering a first bottle filled with a first amount of the recording material for the color for which the consumption amount of the recording material has reached the threshold, and delivering a second bottle filled with a second amount of the recording material for the color for which the consumption amount of the recording material has not reached the threshold, the second amount being determined according to the consumption amount of the recording material corresponding to the color for which the consumption amount of the recording material has not reached the threshold and being smaller than the first amount, and
the image forming apparatus comprising:
one or more processors; and
one or more memories storing instructions that, when executed by the one or more processors, cause the image forming apparatus to:
transmit the information regarding the consumption amount of the recording material for each tank to the information processing apparatus;
clear the consumption amount of the recording material in response to the consumption amount of the recording material having reached a predetermined amount; and
clear the consumption amount of the recording material for which the consumption amount has not reached the threshold, based on a result of the ordering process received from the information processing apparatus.

7. A method for an information processing apparatus configured to communicate with an image forming apparatus that includes a plurality of tanks, each tank being configured to be filled with a recording material of a respective different color, the image forming apparatus configured to form an image on a recording medium using the recording material supplied from the plurality of tanks, the method comprising:
receiving information regarding a consumption amount of the recording material corresponding to each tank transmitted from the image forming apparatus;
determining whether the consumption amount of the recording material for each of the plurality of tanks has reached a predetermined threshold based on the received information regarding the consumption amount of the recording material; and
performing, in a case where the consumption amount of the recording material corresponding to at least one tank of the plurality of tanks has reached the threshold, an ordering process for delivering together a bottle corresponding to a color for which the consumption amount of the recording material has reached the threshold and a bottle corresponding to a color for which the consumption amount of the recording material has not reached the threshold,
wherein the ordering process causes delivering a first bottle filled with a first amount of the recording material for the color for which the consumption amount of the recording material has reached the threshold, and delivering a second bottle filled with a second amount of the recording material for the color for which the consumption amount of the recording material has not reached the threshold, the second amount being determined according to the consumption amount of the recording material corresponding to the color for which the consumption amount of the recording material has not reached the threshold and being smaller than the first amount.
